(19) United States
(12) Patent Application Publication
(10) Pub. No.: US 2025/0244598 A1
(43) Pub. Date: Jul. 31, 2025

(54) Polarization Separating and Converting Meta-Optical Structures

(71) Applicant: COHERENT PHOTONICS LLC, Plainsboro, NJ (US)

(72) Inventors: Michael Soskind, Plainsboro, NJ (US); Yakov Soskind, Plainsboro, NJ (US)

(21) Appl. No.: 18/423,703

(22) Filed: Jan. 26, 2024

(51) Int. Cl. G02B 27/28; B82Y 20/00; G02B 1/00

(52) U.S. Cl. CPC G02B 27/285; B82Y 20/00; G02B 1/002; G02B 2207/101

(57) ABSTRACT

A polarization-separating device includes an optically transmitting substrate and a transmissive meta-surface structure disposed on the substrate. The transmissive meta-surface structure is configured to receive incident light and angularly separate the incident light into orthogonal polarization components. A first polarization component is transmitted by the meta-surface structure without altering a propagation direction of the first polarization component. A a second polarization component is directed by the meta-surface structure at a non-zero angle with respect to a propagation direction of the incident light.

### FIELD OF THE INVENTION

The present invention relates to meta-optical structures that modify the polarization of light. More specifically, it describes meta-optical structures that perform separation and transformation of different polarization components of light. The patent describes polarization beam splitters (PBSs) and polarization converting assemblies (PCAs) with reduced size and weight employing meta-optical structures (MOSs).

### BACKGROUND OF THE INVENTION

Polarization converting assemblies (PCAs) are commonly used in projection displays to improve their efficiency, therefore reducing power consumption and heat dissipation of the system. PCAs are commonly made of assemblies composed of polarization separating components, commonly known as polarization beam splitters (PBSs), and optical phase retardation components. For example, U.S. Pat. No. 9,448,427 “Transparent display using a polarizing beam splitter” describes prism-based reflective polarization converting assemblies for use in conjunction with image-forming displays. Reflective PBSs are made using coatings composed of a stack of thin films, as shown in U.S. Pat. No. 10,712,578 “Polarizing beam splitters providing high resolution images and systems utilizing such beam splitters”. Alternatively, reflective PBSs can be made as surface relief gratings, as described in U.S. Pat. No. 7,301,700 “Polarization beam splitter and optical system using the same, and image displaying apparatus, using the same”.

Another type of PCA employing reflective PBSs is based on metallized gratings with sub-wavelength groove spacings, often referred to as wire-grid polarizers, as described for example in FIG. 7 of U.S. Pat. No. 7,175,280 “Projection Display with Polarization Beam Splitter”. The metallized gratings are fabricated on transparent planar substrates. The wire-grid PBS transmits TE-polarized light and reflects TM-polarized light (FIG. 7). In the projection display apparatus, the PBS substrate is oriented at an angle of 45° with respect to the direction of the incident light (FIG. 3), therefore occupying a substantial axial extent within the projection apparatus.

FIGS. 1a and 1b present schematic layouts of reflective PCAs, where the incident light 101 containing TM and TE polarization components is incident onto reflective PBSs at non-zero incident angle. FIG. 1a presents a PCA layout where the reflective PBS 102 transmits the TE-polarized component 103, and reflects the TM-polarized component 104 towards a mirror 108. After reflection from the mirror 108, TM-polarized light propagates through a half-wave plate 109 that converts the incident TM-polarized light into the output TE-polarized light 110 that propagates collinear to the TE-polarized fraction of light transmitted by the PBS 102. In a similar manner, FIG. 1b presents PCA layout where the reflective PBS 105 transmits the TM-polarized light component 106, and reflects the TE-polarized component 107 towards a mirror 108. After reflection from the mirror 108, TE-polarized light propagates through a half-wave plate 111 that converts the incident TE-polarized light into the output TM-polarized light 112 that propagates collinear to the TM-polarized fraction of light transmitted by the PBS 105.

PCAs with large reflective polarization beam splitter assemblies are relatively heavy and bulky, occupying significant volume within an optical system. To reduce the weight and volume occupied by PCAs, they can be made as an array of smaller-sized reflective polarization prisms, as shown in FIG. 8 of U.S. Pat. No. 9,448,427 “Transparent display using a polarizing beam splitter”, in FIG. 1 of U.S. Pat. No. 6,154,320 “Polarizing conversion device, polarizing illuminations device, and display apparatus and projector using the devices”, and in FIGS. 1 and 2 of U.S. Pat. No. 9,213,225 “Polarization converter for use in a projector apparatus and projector apparatus comprising the polarization converter”. The incoming light is divided by the prisms into regions with smaller lateral dimensions defined by the prism apertures. While an array of smaller-sized reflective polarizing prisms reduces the axial thickness of the polarization conversion system, this type of arrangement is labor intensive, and is therefore relatively expensive to manufacture. The typical size of the prisms within the assembly is a few millimeters, and is limited by constraints associated with manufacturing.

One of the drawbacks of the prism array approach, as stated in U.S. Pat. No. 9,448,427, is the reduction in the view angle of the PBS structure associated with light vignetting by the prism walls as the incident light deviates from the normal. An improvement in viewing angle can be achieved using focusing micro-lens arrays along with smaller sized polarization-converting assemblies, as disclosed in U.S. Pat. No. 9,470,964B2 “Projection display apparatus”. The microlens arrays require accurate alignment with respect to the PBS array and will also add additional axial thickness to the assembly. The resulting PBS assemblies become complex, expensive and difficult to fabricate in high volumes.

Reflective PBSs require relatively large incident angles onto the PBS surface to achieve the optical anisotropy required for separating the different polarization states, as at normal angles of incidence reflective PBSs will do not exhibit optical birefringent properties. In PBS cubes, the angle of incidence is 45°, and can be even larger as is the case in U.S. Pat. No. 5,042,925. Because of the required large incident angle of light, reflective PBSs require significant axial space within optical systems.

Transmissive PBS solutions that separate the incoming light incident onto the PBS substrate at normal incidence, rather than at an angle, have been traditionally based on geometric phase diffraction gratings, also known as Pancharatnam-Berry phase (PBP) gratings. The geometric phase polarization diffraction gratings diffract incident light into (0,±1) diffraction orders as left-hand circularly polarized (LCP) and right-hand circularly polarized (RCP) light. Polarization gratings are also designed to limit diffraction of the incident light into any other orders, i.e. into the (0,0) diffraction order and into diffraction orders higher than (0,±1) orders. Description of the geometric phase diffractive optical elements can be found in J. Kim, et al. “Fabrication of ideal geometric-phase holograms with arbitrary wavefronts.” Optica 2.11 958-964 (2015) and in T. Zhan, et al. “Pancharatnam-Berry optical elements for head-up and near-eye displays.” JOSA B 36.5 D52-D65 (2019).

U.S. Pat. No. 10,969,599 “Polarization conversion using geometric phase and polarization volume hologram optical elements” describes transmissive PCAs that converts incident light into circularly polarized output light. It is based on a combination of optical components including a PBP structure, and a polarization volume hologram (PVH). The PBP structure separates the light, incident onto the substrate at normal incidence, into LCP and RCP polarization states that exit the substrate at an angle. The output angles of the LCP and RCP polarization states have the same absolute value, but have opposite sign, i.e. the two output polarization components will exit the substrate symmetrically with respect to the substrate normal. In addition to the geometric phase grating, the polarization conversion arrangement also includes specifically designed PVHs that transmit one circular polarization without changing its propagation direction, and will deflect the second circular polarization of opposite polarity at an angle with respect to its direction of propagation, while transforming its polarity to match the first circular polarization. The PVH is also designed to produce the deflection angle magnitude of the transformed second polarization to match the non-altered direction of the first circular polarization at the output of the PVH component, so that the output light has a single circular polarization state and propagates at an angle with respect to the PVH substrate. To preserve direction of the incident light an additional light deflection element is required, increasing complexity and size of the polarization conversion solution. The lateral size of the converted output light is at least twice the size of the incident light. The axial length of the polarization converting solution is determined by the deflection angles of the PBP component and the lateral size of the incident light, as shown in FIG. 1A of the patent. Therefore, the polarization conversion arrangement described in U.S. Pat. No. 10,969,599 does not provide a compact solution with reduced axial length.

FIG. 2 presents a schematic layout of a transmissive PCA that converts incident light containing TE and TM polarization components into the output light containing a single linear polarization state. The light 101 incident onto the transmissive PBP PBS 112 is separated into (0,±1) and (0,−1) diffraction orders of opposite circular polarization (RCP and LCP). Diffraction angles of the RCP 113 and the LCP 114 polarization components have the same magnitude and opposing direction with respect to the surface normal of the PBS 112. The RCP 113 and the LCP 114 polarization components are further directed onto the respective quarter-wave plates 115 and 116, that transform them into the respective linear TM-polarized components 117 and 118 propagating in different directions. By changing the angular orientation of the quarter-wave plates 115 and 116 with respect to the RCP 113 and the LCP 114 polarization components, the output light can be also transformed into two linear TE-polarized components propagating into different directions.

Reduced axial length PCAs based on the PBP polarization diffraction gratings are described in U.S. Pat. No. 9,739,448B2 “Patterned polarization grating polarization converter”. It describes patterned PBP polarization gratings along with a patterned retarder elements designed to have multiple matching patterned sub-regions. A matching patterned retarder converts the RCP and LCP polarization states diffracted by the PBP grating into uniform linearly polarized or uniform circularly polarized light. The patterned retarder separation from the PBP grating correspond to the axial position where the two circular polarization states produced by the grating are separate from each other. The reduction in the axial length of the polarization converters is achieved at an expense of increased angular spread of the converted output light. The increase in angular spread of the output light is proportional to the diffraction angles of the RCP and LCP components produced by the PBP gratings.

### SUMMARY OF THE INVENTION

In one aspect, the subject matter described herein provides PCA solutions that can separate the incoming light into different polarization states at normal angles of incidence.

In another aspect, the subject matter described herein provides PCA solutions with reduced axial thicknesses and weight.

In yet another aspect, the subject matter described herein provides PCA solutions that will not significantly increase the angular spread of the converted polarized output light.

In still another aspect, the subject matter described herein provides PCA solutions that can be integrated with pixelated arrays of light-emitting sources, such as arrays of light-emitting diodes (LEDs), organic LEDs (OLEDs), and vertical cavity surface-emitting lasers (VCSELs).

In still another aspect, the subject matter described herein provides PCA solutions that can be fabricated in high volumes using established high throughput techniques, such as optical lithography or nano-replication

One or more of the objectives are achieved, in some embodiments, by employing PCAs that incorporate various combinations of transmissive PBS meta-surfaces, meta-surface phase retarders, and meta-surface deflectors. PBS meta-surfaces, light deflectors and phase retarders are fabricated on thin wafers made of optically transparent materials using established high throughput lithographic techniques and nano-imprint technologies. Transmissive PBS meta-surfaces employed herein are designed to exhibit optical birefringence at normal angles of incidence on the PBS substrates.

Meta-optic phase surfaces, also referred to as meta-surfaces, are composed of surface-relief sub-wavelength structures, also known as meta-atoms, that control properties of light on a sub-wavelength level. In the following description the terms “meta-atoms” and “sub-wavelength structures” will be used interchangeably. Meta-atoms can take a variety of shapes and sizes that depend on the meta-surface design and can be fabricated from different materials. Materials with high refractive indices are often used, such as titanium dioxide (TiO₂), silicon nitride (Si₃N₄), and silicon (Si). Several meta-atoms with different shapes and sizes are often arranged into groups, also referred to as “meta-molecules”. In the following description the terms “meta-molecules” and “groups of meta-atoms” will be used interchangeably. The size, shape, and the number of meta-atoms within the meta-molecule depend on the meta-molecule's design.

Meta-molecules can be fabricated and arranged into meta-surfaces functioning as transmissive polarization sensitive meta-surfaces that spatially separate incident light into different polarization states with different propagation directions. The separation angle between different polarization states is proportional to the wavelength of light and inversely proportional to the grating period. Lateral dimensions of the meta-molecules within the PBS meta-grating are comparable to the wavelength of light, so that the diffraction angles can be made relatively large. The meta-molecules can also be fabricated and arranged into meta-surfaces functioning as phase retarders, such as quarter-wave plates and half-wave plates. The phase retarders can be made as patterned regions containing meta-molecules that are aligned with emitting pixels of the displays. The patterned retardation regions can be made comparable in size to the display pixels.

Meta-molecules can be also designed and arranged into meta-surfaces functioning as meta-lenses or meta-lens arrays. Meta-lens arrays can be employed to improve light collimation, i.e. to reduce divergence of light emitted from the display pixels. The size and spacing of the meta-lenses within meta-lens arrays are made to match the display pixels' spacing.

Meta-surfaces can be composed of a single layer containing meta-molecules, or of multiple layers containing meta-molecules. Meta-surfaces with different arrangements of the meta-molecules, including polarization separating meta-surfaces, meta-retarders, meta-surface deflectors and meta-lenses can be further integrated into multi-layer assemblies to form compact meta-optics structures, including PCAs.

Individual wafers with meta-surface PBSs and optical phase retarders can be diced to their desired sizes, and used individually, or within multi-element optical assemblies. Individual wafers containing meta-surfaces can also be aligned, bonded together, and diced into individual compact monolithic optical assemblies. Meta-surface PCAs can be placed in proximity to, or integrated with pixelated displays, resulting in compact display assemblies with specific polarization properties of the output light. The PCA components can be made as two-dimensional arrays of patterned regions, with the regions' spacings and sizes matching the pixels' spacings in the pixelated displays. PCA integration can be done either monolithically, as part of the display fabrication process, or using hybrid integration during post-processing operations. In the case of hybrid integration, the patterned PCA regions are aligned to the display pixel array.

The features of the present invention, including construction and operational details of the embodiments will be explained in detail in the following embodiments. It is understood by those skilled in the art that the present invention is not limited to the following embodiments, and a great number of alternative meta-optics PBS and phase retarder designs can be done by changing materials, meta-atoms shapes, sizes and arrangements within different meta-molecules, etc.

### BRIEF DESCRIPTION OF THE DRAWINGS

FIG. 1a presents the schematic layout of a PCA employing a reflective PBS that converts incident light into TE-polarized light.

FIG. 1b presents the schematic layout of a PCA employing a reflective PBS that converts incident light into TM-polarized light.

FIG. 2 presents the schematic layout of a PCA employing a PBP grating that converts incident light into two transmitted orthogonal circularly polarized components diffracted into two directions symmetric to the PBP substrate normal.

FIG. 3 illustrates notations of different diffraction orders of light in angular U-V space.

FIG. 4a presents the schematic layout of a PCA of the first embodiment that converts incident light into TM-polarized output light.

FIG. 4b presents the schematic layout of a PCA of the first embodiment that converts incident light into TE-polarized output light.

FIG. 4c presents the schematic layout of an alternative PCA of the first embodiment that converts incident light into TM-polarized output light.

FIG. 4d presents the schematic layout of an alternative PCA of the first embodiment that converts incident light into TE-polarized output light.

FIG. 5a presents the YZ-plane view of a patterned PCA array of the first embodiment fabricated on two substrates separated by an air gap, that converts the incident light into TM-polarized output light.

FIG. 5b presents the YZ-plane view of an alternative patterned PCA array of the first embodiment fabricated on a single substrate, that converts the incident light into TM-polarized output light.

FIG. 5c presents the YZ-plane view of an alternative patterned PCA array of the first embodiment fabricated on a single substrate, that converts the incident light into circularly polarized output light.

FIG. 6 presents the YZ-plane view of an emitter array combined with patterned PCA of the first embodiment, that converts the incident light into TM linearly polarized output light.

FIG. 7a presents a YZ-plane view of a PBS fabricated as a single meta-surface layer on the PBS substrate.

FIG. 7b presents a YZ-plane view of a PBS fabricated as two different meta-surfaces on opposite sides of the PBS substrate.

FIG. 7c presents a YZ-plane view of a PBS fabricated on a single side of the PBS substrate as a two-layer meta-surface.

FIG. 7d presents a YZ-plane view of a PBS composed of two substrates with meta-surface layers placed between the two substrates.

FIG. 8a presents the XY-plane view of a single layer meta-surface PBS shown in FIG. 7a.

FIG. 8b presents the XY-plane view of an alternative single layer meta-surface PBS shown in FIG. 7a.

FIG. 8c presents a third exemplary design of a single layer PBS meta-surface optimized for operation in the infrared region at a wavelength of 1.65 microns.

FIG. 9a presents the XY-plane view of a first meta-surface layer of the two-layer PBS fabricated on the first surface of the substrate, as shown in FIG. 7b.

FIG. 9b presents the XY-plane view of a second meta-surface layer of the two-layer PBS fabricated on the second surface of the substrate, as shown in FIG. 7b.

FIG. 10a presents the ZX-plane view of a two-layer meta-surface PBS shown in FIG. 7c.

FIG. 10b presents the XY-plane view of a two-layer meta-surface PBS shown in FIG. 7c.

FIG. 10c presents the XY-plane view of a first meta-surface layer of the two-layer PBS shown in FIG. 7c.

FIG. 10d presents the XY-plane view of a second meta-surface layer of the two-layer PBS shown in FIG. 7c.

FIG. 11a presents the ZX-plane view of a two-layer meta-surface PBS shown in FIG. 7d.

FIG. 11b presents the XY-plane view of a two-layer meta-surface PBS shown in FIG. 7d.

FIG. 11c presents the XY-plane view of a first meta-surface layer of the two-layer PBS shown in FIG. 7d.

FIG. 11d presents the XY-plane view of a second meta-surface layer of the two-layer PBS shown in FIG. 7d.

FIG. 12 presents the XY-plane view of a meta-surface half-wave plate phase retarder of the first embodiment.

FIG. 13a presents the schematic layout of the PCA of the second embodiment that converts incident light into TM-polarized output light.

FIG. 13b presents the schematic layout of an alternative PCA of the second embodiment that converts incident light into TE-polarized output light.

FIG. 14 presents the YZ-plane view of an emitter array, combined with the patterned PCA array of the second embodiment, that converts incident light from an emitter array into TM linearly polarized output light.

FIG. 15 presents the XY-plane view of a single layer meta-surface PBS of the second embodiment.

FIG. 16 presents the XY-plane view of a meta-surface deflection grating of the second embodiment.

FIG. 17a presents the schematic layout of the PCA of the third embodiment that converts incident light into TM-polarized output light.

FIG. 17b presents the schematic layout of an alternative PCA of the third embodiment that converts incident light into TE-polarized output light.

FIG. 18a presents the schematic three-dimensional view of the meta-surface PBS of the third embodiment that deflects TE-polarized light into 4 different diffraction orders and transmits TM-polarized incident light without deflection.

FIG. 18b presents the schematic three-dimensional view of an alternative meta-surface PBS of the third embodiment that deflects TM-polarized light into 4 different diffraction orders and transmits TE-polarized incident light without deflection.

FIG. 19 presents the XY-plane view of a single layer meta-surface PBS of the third embodiment.

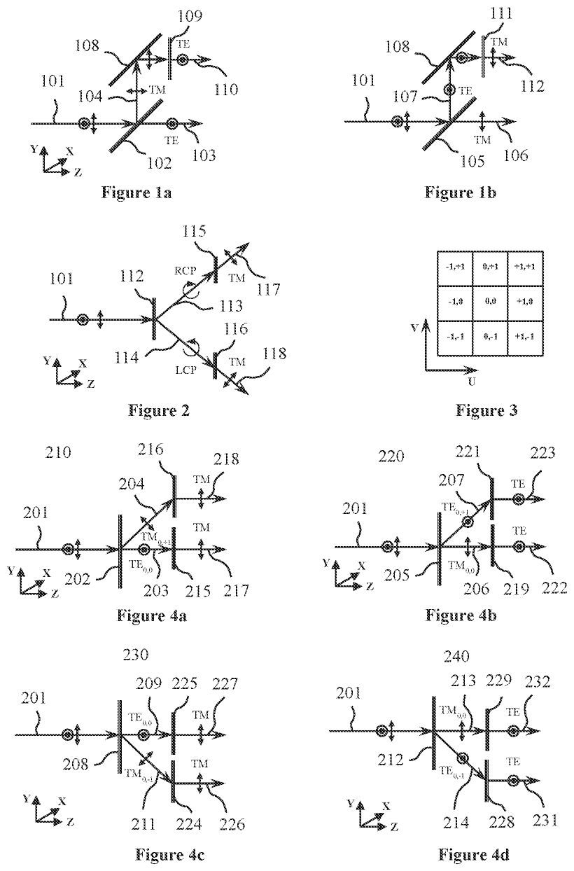

### DETAILED DESCRIPTION

The present invention will be further described in detail in the form of specific embodiments. However, the present invention is not limited to only the specific embodiments described herein, and can be employed in a broad range of various alterations of the disclosed embodiments. To achieve the desired objectives, embodiments of the present disclosure are based on PCAs composed of three types of transmissive meta-surfaces. The first type of meta-surface performs angular polarization separation and is referred to as a PBS meta-surface. The second type of meta-surface performs optical phase retardation of polarized light. The third type of meta-surface performs angular deflection of polarized light.

An optical field can generally be specified via its intensity, degree of polarization, plane of polarization, and ellipticity. The electric field can generally be parametrized as two orthogonal waves traveling in a particular Z direction, with the direction of propagation referred to as the k vector. The two orthogonal x and y components (Eₓ, E_{y}) at a particular time t can be represented as two propagating sine waves with amplitudes (Eₓ₀, E_{y0}) and phases (φₓ, φ_{y}):

$${E}_{x} = {E}_{x 0} sin ( ω t + {ϕ}_{x} ) \qquad Equation 1$$

$${E}_{y} = {E}_{y 0} sin ( ω t + {ϕ}_{y} ) \qquad Equation 2$$

where ω is the angular frequency of the electromagnetic radiation.

Alternatively, the electric field can be parametrized as a set of orthogonal components with respect to the major axis of the polarization ellipse. This results in the principal axes of the ellipse making an angle θ with respect to the x axis, and its orthogonal angle is at Θ+90, which represents the vibration in a new coordinate space.

$${E}_{Θ} = {E}_{0} cos β sin ω t \qquad Equation 3$$

$${E}_{Θ + π / 2} = {E}_{0} sin β cos ω t \qquad Equation 4$$

where β represents the angle, whose tangent is the ratio of the major and minor axes of the polarization ellipse.

The above equations are used to define the Stokes parameters. The Stokes parameters represent an elliptically polarized beam, such that:

$$S = ( \begin{matrix}{S}_{0} \\ {S}_{1} \\ {S}_{2} \\ {S}_{3}\end{matrix} ) = ( \begin{matrix}{E}_{x 0}^{2} + {E}_{y 0}^{2} \\ {E}_{x 0}^{2} - {E}_{y 0}^{2} \\ 2 {E}_{x 0} {E}_{y 0} cos ( {ϕ}_{x} - {ϕ}_{y} ) \\ 2 {E}_{x 0} {E}_{y 0} sin ( {ϕ}_{x} - {ϕ}_{y} )\end{matrix} ) \qquad Equation 5$$

The transmissive PBS meta-surfaces split incoming light into orthogonal polarization states when the light is incident onto the PBS substrate along the surface normal. The PBS meta-surfaces of the present invention are designed to transmit one polarization into the (0,0) diffraction order without changing its propagation direction, i.e. the polarization state experiences no diffraction by the PBS meta-surface. The PBS meta-surfaces are also designed to diffract a second polarization state into one or more non-zero diffraction orders, therefore deflecting the second polarization state from the incident light propagation direction. FIG. 3 illustrates notations of different diffraction orders of the transmitted light in angular U-V space.

PBS devices typically operate by splitting light into one of two common forms of orthogonal polarizations. The orthogonal polarizations traditionally take the form of orthogonal linearly polarized radiation, or circularly polarized radiation. In the case of linear polarization, linear horizontal polarization (LHP) and linear vertical polarization (LVP) are the most common bases for separation, and are represented via Stokes vectors (SLHP, SLVP).

$${S}_{LHP} = ( \begin{matrix}1 \\ 1 \\ 0 \\ 0\end{matrix} ) \qquad Equation 6$$

$${S}_{LVP} = ( \begin{matrix}1 \\ - 1 \\ 0 \\ 0\end{matrix} ) \qquad Equation 7$$

Additional bases for separation exist, such as the orthogonal pair of left- and right-hand circularly polarized light (LCP, RCP). In this case, the Stokes vectors (S_{LCP}, S_{RCP}) take the form:

$${S}_{LCP} = ( \begin{matrix}1 \\ 0 \\ 0 \\ - 1\end{matrix} ) \qquad Equation 8$$

$${S}_{RCP} = ( \begin{matrix}1 \\ 0 \\ 0 \\ 1\end{matrix} ) \qquad Equation 9$$

To achieve polarization conversion, additional meta-surface types are used in conjunction with the transmissive PBS meta-surfaces. One of the additional meta-surface types functions as a phase retarder, such as a half-wave plate or quarter-wave plate. The phase retarder meta-surface transforms incident light in the (0,0) order into output light with a different polarization state. The polarization transformation can be represented using the Stokes vectors described above.

A matrix formalism has been established relating the input Stokes vector of an optical system to the output Stokes vector of that system. This is known as the Mueller matrix, a 4×4 matrix containing real elements. The relation between the Mueller matrix (M) and the input Stokes (Sᵢₙ) and output Stokes (Sₒᵤₜ) vectors can be represented by the matrix multiplication Sₒᵤₜ=MSᵢₙ. An optical component or system has unique Mueller matrix representation. Transmission through free space takes the trivial form of the identity matrix for a non-absorptive medium. Waveplates, or phase retarders, can be represented by a Mueller matrix of the following form:

$$M = ( \begin{matrix}1 & 0 & 0 & 0 \\ 0 & 1 & 0 & 0 \\ 0 & 0 & cos ϕ & sin ϕ \\ 0 & 0 & - sin ϕ & cos ϕ\end{matrix} ) \qquad Equation 10$$

where φ is the phase shift with respect to the fast-axis of the optical system.

In the case of a quarter wave (M_{QWP},φ=) 90° and half wave (M_{HWP}φ=) 180° plate, equation 10 can be simplified, respectively, as:

$${M}_{QWP} = ( \begin{matrix}1 & 0 & 0 & 0 \\ 0 & 1 & 0 & 0 \\ 0 & 0 & 0 & 1 \\ 0 & 0 & - 1 & 0\end{matrix} ) \qquad Equation 11$$

$${M}_{HWP} = ( \begin{matrix}1 & 0 & 0 & 0 \\ 0 & 1 & 0 & 0 \\ 0 & 0 & - 1 & 0 \\ 0 & 0 & 0 & - 1\end{matrix} ) \qquad Equation 12$$

Both quarter wave and half wave phase retarders are detailed in the following disclosure.

Another meta-surface type functions as a transmissive light deflector. The light deflector meta-surface deflects non-zero diffracted orders to be collinear to the direction of the non-diffracted (0,0) order transformed by the phase retarder meta-surface. The transmissive light deflector meta-surface may have the same structure as the PBS meta-surface, and needs to be rotated by 180 degrees with respect to the PBS meta-surface around the light propagation direction defined by Z axis. This rotated transmissive meta-surface PBS light deflector diffracts incident polarized light at an angle equal in magnitude and opposite in direction to the diffraction angle at the output of the PBS meta-surface. The output light from the rotated transmissive meta-surface PBS light deflector will be directed along the direction of non-diffracted light, while maintaining polarization of the incident light. The transmissive light deflector meta-surface can be also made as a transmissive meta-surface grating that diffracts the transmitted polarized light at an angle equal in magnitude and opposite in direction to the PBS diffraction angle. The output of the transmissive light deflector meta-surface grating will be directed along the direction of the non-diffracted light, while maintaining the polarization state of the incident light. As a result, the output light from the PCA will contain a single desired polarization state propagating in the direction of the incident light.

Embodiments of the PCA described herein can be also made to contain patterned meta-surface sub-regions for integration with pixelated displays and image-projecting systems.

Illustrative design details of the PBSs, meta-surface retarders and their assemblies into PCA structures will be described in detail in the following exemplary embodiments.

### First Embodiment

The first embodiment described herein contains a transmissive PBS meta-surface that splits the incident light into two optical paths with different polarization states. One optical path contains a first polarization state transmitted into the (0,0) diffraction order, and the second optical path contains a second polarization state transmitted into either into the (0,+1) or into the (0,−1) diffraction orders. Notation of TE-polarized light in the following associated figures is defined as a solid dot surrounded by a circle. Notation of TM-polarized light in the following associated figures is defines as a double-arrow line drawn perpendicular to the direction of light propagation.

FIGS. 4a through 4d present different variations of the PCAs of the first embodiment. FIG. 4a shows the view of a PCA arrangement 210 in the YZ plane. The PCA arrangement 210 contains a transmissive PBS meta-surface 202 that splits the incident light 201 into TE_{0,0} polarization directed into the (0,0) diffraction order 203, and into TM_{0,+1} polarization directed into the (0,±1) diffraction order 204. The direction of the transmitted TE_{0,0} polarization 203 coincides with the direction of the incident light 201. The direction of the diffracted TM_{0,+1} polarization 204 is at a non-zero angle with respect to the direction of the incident light 201. The PCA 210 also contains a transmissive meta-surface half-wave phase retarder 215 and transmissive meta-surface deflector 216. The half-wave retarder 215 transforms incident TE_{0,0} polarization 203 into the output TM-polarized light 217 without changing propagation direction. The transmissive meta-surface deflector 216 diffracts incident TM_{0,+1} polarization 204 at an angle equal in magnitude and opposite in sign to the angle diffracted by the PBS meta-surface 202. As a result, the output from the transmissive meta-surface deflector 216 will contain TM-polarized light 218 collinear to the TM-polarized light 217 at the output of the phase retarder 215. TM-polarized fractions of light 217 and 218 at the output of the PCA 210 are collinear to the incident light 201.

FIG. 4b shows the view of a PCA arrangement 220 in the YZ plane. The PCA arrangement 220 contains a transmissive PBS meta-surface 205 that splits the incident light 201 into TM_{0,0} polarization directed into the (0,0) diffraction order 206, and into TE_{0,+1} polarization directed into the (0,+1) diffraction order 207. Direction of the transmitted TM_{0,0} polarization 206 coincides with the direction of the incident light 201. Direction of the diffracted TE_{0,+1} polarization 207 is at a non-zero angle with respect to the direction of the incident light 201. The PCA 220 also contains transmissive meta-surface half-wave phase retarder 219 and transmissive meta-surface deflector 221. The phase retarder 219 transforms incident TM_{0,0} polarization 206 into the output TE-polarized light 222 without changing propagation direction. Transmissive meta-surface deflector 221 diffracts incident TE_{0,+1} polarization 207 at an angle equal in magnitude and opposite in sign to the diffraction angle by the PBS meta-surface 205. As a result, the output from the transmissive meta-surface deflector 221 will contain TE-polarized light 223 collinear to the TE-polarized light 222 at the output of the phase retarder 219. TE-polarized fractions of light 222 and 223 at the output of the PCA 220 are collinear to the incident light 201.

FIG. 4c shows the schematic layout of a PCA arrangement 230. The PCA arrangement 230 contains transmissive PBS meta-surface 208 that splits the incident light 201 into TE_{0,0} polarization directed into the (0,0) diffraction order 209, and into TM_{0,-1} polarization directed into the (0,−1) diffraction order 211. Direction of the transmitted TE_{0,0} polarization 209 coincides with the direction of the incident light 201. Direction of the diffracted TM_{0,-1} polarization 211 is at a non-zero angle with respect to the direction of the incident light 201. The PCA 230 also contains transmissive meta-surface half-wave phase retarder 225 and transmissive meta-surface deflector 224. The phase retarder 225 transforms incident TE_{0,0} polarization 209 into the output TM-polarized light 227 without changing propagation direction. Transmissive meta-surface deflector 224 diffracts incident TM_{0,-1} polarization 211 at an angle equal in magnitude and opposite in sign to the diffraction angle by the PBS meta-surface 208. As a result, the output from the transmissive meta-surface deflector 224 will contain TM-polarized light 226 collinear to the TM-polarized light 227 at the output of the phase retarder 225. TM-polarized fractions of light 226 and 227 at the output of the PCA 230 are collinear to the incident light 201.

FIG. 4d shows the schematic layout of a PCA arrangement 240. The PCA arrangement 240 contains transmissive PBS meta-surface 212 that splits the incident light 201 into TM_{0,0} polarization directed into the (0,0) diffraction order 213, and into TE_{0,-1} polarization directed into the (0,−1) diffraction order 214. Direction of the transmitted TM_{0,0} polarization 213 coincides with the direction of the incident light 201. Direction of the diffracted TE_{0,-1} polarization 214 is at a non-zero angle with respect to the direction of the incident light 201. The PCA 240 also contains transmissive meta-surface half-wave phase retarder 229 and transmissive meta-surface deflector 228. The phase retarder 229 transforms incident TM_{0,0} polarization 213 into the output TE-polarized light 232 without changing propagation direction. Transmissive meta-surface deflector 228 diffracts incident TE_{0,-1} polarization 214 at an angle equal in magnitude and opposite in sign to the diffraction angle by the PBS meta-surface 212. As a result, the output from the transmissive meta-surface deflector 228 will contain TE-polarized light 231 collinear to the TE-polarized light 232 at the output of the phase retarder 229. TE-polarized fractions of light 231 and 232 at the output of the PCA 240 are collinear to the incident light 201.

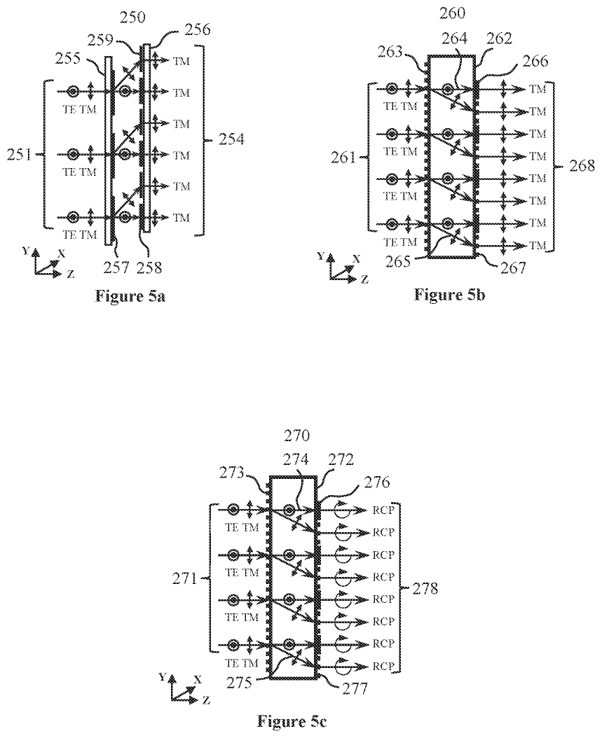

Meta-surfaces are well suited for wafer-level fabrication and assembly into the PCA arrays. FIG. 5a presents the YZ-plane view of a patterned PCA assembly 250 in the YZ-plane that converts incident light from multiple input beams 251 containing TE and TM polarizations into TM-polarized output light 254, similar to that shown in FIG. 4a. The PCA assembly includes two substrates 255 and 256 containing patterned meta-surface regions 257, 258 and 259 forming PCA sub-assemblies. While only 3 groups of meta-surface regions 257, 258 and 259 are shown in FIG. 5a, a larger number of meta-surface groups can be arranged into one-dimensional and two-dimensional arrays in a manner shown in FIG. 5a. Any of the PCA types in FIGS. 4a through 4d can be used to form the meta-surface groups within the arrays. Meta-surface regions 257, 258 and 259 in FIG. 5a are shown with gaps between them. The meta-surface regions 257, 258 and 259 can be also fabricated with no gaps between the individual regions. Multiple smaller PCA sub-assemblies shown in FIGS. 4a through 4d can be assembled into one-dimensional and two-dimensional arrays to convert incident light into TE-polarized and TM-polarized light.

FIG. 5b presents the YZ-plane view of a monolithic PCA assembly 260 that converts incident light from multiple input beams 261 containing TE and TM polarizations into TM-polarized output light 268 that is collinear with the direction of the incident light, similar to that shown in FIG. 4c. The PCA assembly includes a single substrate 262 containing two meta-surface layers on both sides of the substrate. Input light 261 containing TE and TM polarizations is incident onto the first meta-surface layer 263 that functions as PBS that transmits TE-polarized light with no deviation from its original direction, and deflects TM-polarized light as it enters the substrate 262. TE and TM polarizations are spatially separated from each other as they reach the opposite surface of the substrate 262. Individual fractions of TE-polarized light are incident onto sub-regions of the second meta-surface that function as half-wave phase structures, and are transformed int TM-polarized light that travels collinear with the direction of incident light 261. Individual fractions of TM-polarized light are incident onto sub-regions of the second meta-surface that work as transmissive light deflectors that deflect TM-polarized light at an angle equal in magnitude and opposite in sign to the deflection angle of the first meta-surface layer 263. TM-polarized fractions of light at the output of the deflection sub-regions are collinear with the direction of the incident light 261 and the light fractions transformed by the half-wave meta-surface phase structures.

FIG. 5c presents the YZ-plane view of a monolithic PCA assembly 270 that converts incident light from multiple input beams 271 containing TE and TM polarizations into righthand circular polarized (RCP) output light 278 that is collinear with the direction of the incident light. The PCA assembly is comprised of a single substrate 272 containing two meta-surface layers on both sides of the substrate. Input light 271 containing TE and TM polarizations is incident onto the first meta-surface layer 273 that functions as a PBS, transmitting TE-polarized light with no deviation from its original direction, and deflecting TM-polarized light as it enters the substrate 272, similar to that shown in FIG. 4c. The TE and TM polarizations are spatially separated from each other after reaching the opposite side of the substrate 272. Individual fractions of TE-polarized light are incident onto a first type of sub-regions of the second meta-surface that work as quarter-wave phase surfaces transforming the incident TE-polarized light into RCP light that travels collinear with the direction of incident light 271. These quarter wave phase retarders are also known as quarter wave plates, and their prescription is provided in Table 11. Individual fractions of TM-polarized light are incident onto a second type of sub-regions of the second meta-surface that combine the functions of transmissive light deflectors and quarter-wave phase surfaces. The second type of sub-regions deflects TM-polarized light at an angle equal in magnitude and opposite in sign to the deflection angle of the first meta-surface layer 273, and also introduces a phase delay required for conversion of the TM-polarized fractions of light into RCP light at the output of the deflection sub-regions that propagates collinear with the direction of the incident light 271 and the RCP light fractions transformed by the first type of the quarter-wave meta-surface phase sub-regions.

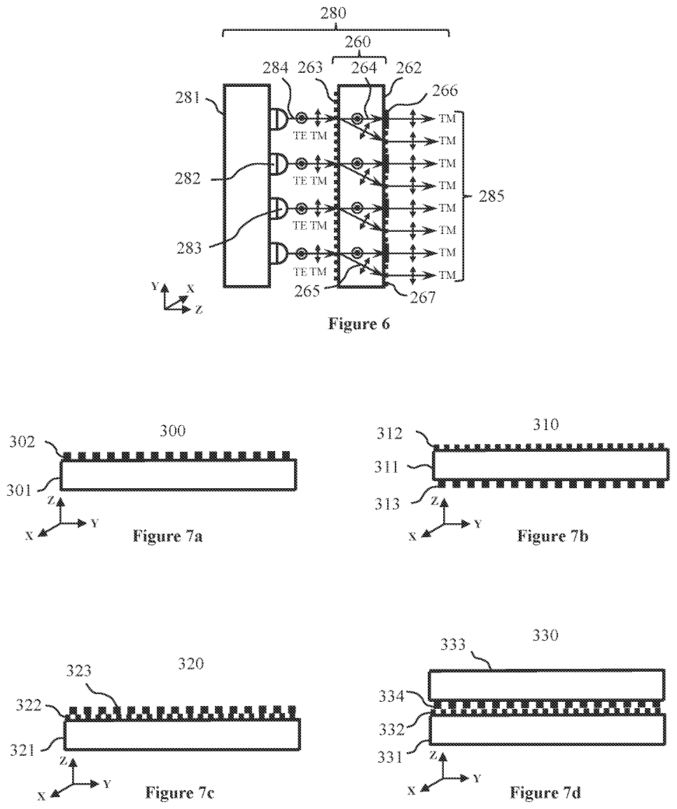

FIG. 6 presents the YZ-plane view of an arrangement 280 that integrates an emitter array with monolithic PCA converter 260 that converts incident light 284 from multiple emitters containing TE and TM polarizations into TM-polarized output light 285 that is collinear with the direction of the incident light. The emitter array is comprised of a substrate 281 and a number of individual emitters 282 assembled onto the substrate 281. The emitters 282 may contain micro-lenses 283 for reducing divergence of light emitted by the emitters. While refractive micro-lenses are shown in FIG. 6, diffractive micro-lenses or meta-optics micro-lenses can be integrated with the emitters instead. A micro-lens array with the lens spacings matching the spacing between the emitters can be also placed in proximity to the emitters array to perform light collimation. The PCA assembly 260 is the same as in FIG. 5b, and its construction and operation was described earlier. As a result, the collimated emitters light 284 is transformed by the PCA assembly 260 into linear TM-polarized light 285.

The following FIGS. 7a through 7d present illustrative construction details of different transmissive PBS meta-surfaces that can be used as part of the PCA structures. In general, the meta-surfaces may be produced in any number of different ways that depart from those shown herein. FIG. 7a shows transmissive PBS meta-surface 300 fabricated as a single meta-surface layer 302 on the PBS substrate 301. The substrate 301 is made of a material transparent to the operating wavelength of light. Depending on the specific wavelength, a variety of substrates with different sizes and thicknesses, made of crystalline, poly-crystalline and amorphous optical materials can be used. For operating wavelengths in the visible spectra, for instance, a variety of optical glasses, such as BK-7 or fused silica, can be used for meta-surface substrates fabrication. Meta-surface layer 302 is composed of meta-atoms that are typically made of materials that have relatively high indices of refraction. Silicon nitride Si₃N₄ and titanium dioxide TiO₂ are commonly used for fabrication of meta-surfaces operating in the visible spectrum. In the infrared, other substrate materials, such as amorphous or poly-crystalline silicon Si, zinc selenide ZnSe, and sapphire can be used. Silicon nitride Si₃N₄ and silicon Si are commonly used for fabrication of meta-surfaces operating in the infrared. The meta-surface 302 can be fabricated on the substrate 301 surface that faces the incident light or can be fabricated on the substrate side opposing the incident light. FIG. 7b shows transmissive PBS structure 310 fabricated as two meta-surface layers 312 and 313 on both surfaces of the PBS substrate 311. FIG. 7c shows transmissive PBS structure 320 comprised of two meta-surface layers 322 and 323 fabricated on the same side of the PBS substrate 321. FIG. 7d shows transmissive PBS structure 330 comprised of two transparent substrates 331 and 333, each substrate containing a respective meta-surface layer 322 and 324. The two substrates 331 and 333 are placed in proximity, with the meta-surfaces 332 and 334 facing each other. Meta-surfaces shown in FIGS. 7a through 7d can be also incapsulated within a lower-index material, rather than being surrounded by air.

Illustrative design details of the different meta-surfaces of the first embodiment will be further described by the following examples. The presented examples represent exemplary designs, and a great number of other designs based on alterations of the meta-atom shapes, sizes, locations, spacings, periodicity, material compositions, etc. can be also produced to result in similar functions.

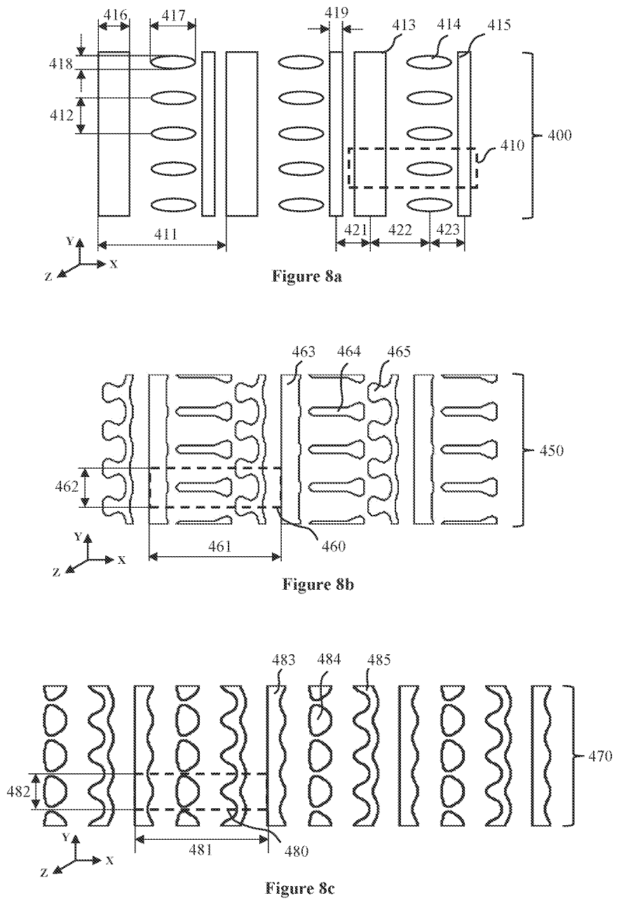

FIG. 8a presents a first exemplary design of a single layer PBS meta-surface composed of individual meta-molecules, each meta-molecule containing 3 different nano-structures. The meta-molecules are periodically tiled in X-axis and Y-axis directions. The meta-surface layer 400 is fabricated onto the PBS substrate side facing the incident light. Table 1 contains prescription details of the PBS meta-surface in FIG. 8a. The PBS meta-surface layer 400 consists of meta-molecules, shown in FIG. 8a by dashed rectangle 410, that have periodicity in the X-axis and in the Y-axis directions. The meta-molecule X-axis 411 and Y-axis 412 values are shown in Table 1. Each meta-molecule 410 contains two ridges 413 and 415 and an elliptical nano-pillar 414. The ridges 413 and 415 have respective widths 416 and 419. The elliptical nano-pillar 414 has width 417 corresponding to the ellipse major axis, and the height 418 corresponding to the ellipse minor axis. The meta-surface structure is fabricated from Si₃N₄ layer, and is designed to operate at the wavelength of 0.55 microns. Individual meta-molecule components 413, 414, and 415 are spaced in X-axis direction by the respective distances 421, 422, and 423. Table 1 contains geometrical information of the first exemplary design of a single layer PBS meta-surface 400.

TABLE 1

| | Parameter | | | | |
|---|---|---|---|---|---|
| | Ridge X | Ridge X | Pillar X | Pillar Y | Si₃N₄ |
| | width | width | size | size | layer |
| | 416 (nm) | 419 (nm) | 417 (nm) | 418 (nm) | thickness (μ) |
| Value | 120 | 50 | 285 | 85 | 0.5 |

| | Parameter | | | | |
|---|---|---|---|---|---|
| | X period | Y period | X spacing | X spacing | X spacing |
| | 411 | 412 | 421 | 422 | 423 |
| | (nm) | (nm) | (nm) | (nm) | (nm) |
| Value | 670 | 275 | 190 | 295 | 185 |

PBS meta-surface 400 will transmit 98% of the incident TM-polarized light without deflection as TM_{0,0} light, and will deflect 87% of the incident TE-polarized light diffracted as TE_{0,+1} light into (0,+1) diffraction order. When the incident light is at normal incidence with respect to the PBS substrate, the output deflection angle of the TE_{0,+1} polarization in air will be 55.3 degrees.

FIG. 8b presents a second exemplary design of a single layer PBS meta-surface composed of individual meta-molecules. The meta-molecules are tiled periodically in X-axis and Y-axis directions. The meta-surface layer 450 is fabricated onto the PBS substrate side opposing direction of the incident light. Table 2 contains prescription details of the PBS meta-surface layer 450 shown in FIG. 8b. The meta-surface layer 450 is designed using so called topology optimization technique, as described for example in the following reference: J. A. Fan, “Freeform metasurface design based on topology optimization.” MRS Bulletin 45 (2020): 196-201. The resulting meta-surface structure is composed of freeform-shaped primitives. The PBS meta-surface layer 450 consists of rectangular meta-molecules, with the boundaries shown in FIG. 8b by a dashed rectangle 460. The meta-molecules are periodically tiled in X-axis and in Y-axis directions. The meta-molecule dimensions in the X-axis 411 and the Y-axis 412 are listed in Table 2. Each meta-molecule 460 contains two freeform-shaped ridges 463 and 465 and a single freeform-shaped nano-pillar 464. Outlines and dimensions of the freeform geometry of the meta-surface layer 450 are defined by a CAD file. The meta-surface structure is fabricated from a Si₃N₄ layer, and is designed to operate at the wavelength of 0.55 microns. Table 2 contains meta-molecules geometrical information of the second exemplary design of a single layer PBS meta-surface 450.

TABLE 2

| X period 461 (nm) | Y period 462 (nm) | Si₃N₄ layer thickness (μ) |
|---|---|---|
| 975 | 275 | 0.5 |

PBS meta-surface 450 transmits 91.0% of the incident TM-polarized light without deflection as TM_{0,0} diffraction order, and diffracts 83.6% of the incident TE-polarized light as TE_{0,+1} light into (0,+1) diffraction order. When the incident light is at normal incidence with respect to the PBS substrate, the deflection angle of the diffracted TE-polarized light in air equals 34.3 degrees.

PBS meta-surfaces, including those used in conjunction with PCAs for polarization conversion of light, can be designed to operate at a variety of wavelengths. As an example, FIG. 8c presents a third exemplary design of a single layer PBS meta-surface optimized for operation in the infrared region at a wavelength of 1.65 microns. Meta-surface PBSs are not limited to the visible and infrared, and can be designed for any wavelength within the optical spectrum. The meta-surface layer 470 in FIG. 8c is fabricated on the side of the PBS substrate facing the incident light. The PBS substrate is made of fused silica glass. Table 3 contains the prescription details for the PBS meta-surface layer 470 of the third exemplary design shown in FIG. 8c. The meta-surface layer 470 is designed using topology optimization, with the resulting meta-surface structure being composed of freeform-shaped structures. The PBS meta-surface layer 470 consists of rectangular meta-molecules, with boundaries shown in FIG. 8c by a dashed rectangle 480. The meta-molecules are periodically tiled in both the X-direction and in Y-direction. The meta-molecule dimensions in the X-axis 481 and the Y-axis 482 are listed in Table 3. Each meta-molecule 480 contains two freeform-shaped ridges 483 and 485 and a freeform-shaped nano-pillar 484. Outlines and dimensions of the freeform geometry of the meta-surface layer 470 are defined by a CAD file. The meta-surface structure 470 is fabricated from amorphous silicon (Si).

TABLE 3

| X period 481 (nm) | Y period 482 (nm) | Si layer thickness (μ) |
|---|---|---|
| 1525 | 387 | 1.010 |

PBS meta-surface layer 470 transmits 94.8% of the incident TM-polarized light without deflection in the (0,0) diffraction order, and diffracts 92.9% of the incident TE-polarized light as TE_{0,+1} light into the (0,+1) diffraction order. When the incident light is at normal incidence with respect to the PBS substrate, the deflection angle of the diffracted TE-polarized light in the substrate equals 48.6 degrees. The TE-polarized light after the PBS meta-surface exceeds the total internal reflection (TIR) angle of the substrate material, and will propagate as an evanescent wave within the substrate. To extract the evanescent TE-polarized light from the substrate, another out-coupling meta-surface structure is typically employed.

The second meta-surface PBS design of the first embodiment is based on a two-layer meta-surface approach shown in FIG. 7b. The two meta-surface layers are placed on both sides of the substrate. Each of the meta-surfaces has a distinctly different function. The first meta-surface, facing the incident light, is made as a polarization insensitive meta-grating that deflects both TE and TM polarizations at an angle with respect to the incident light direction. The second meta-surface, fabricated on an opposite substrate surface, is a PBS grating that operates at non-zero angles of incidence, transmitting one of the polarization states, and deflecting the other polarization state. Both meta-surfaces are aligned with respect to each other to perform beam deflection and polarization beam-splitting within the same plane, and have the same periodicity within the deflection plane.

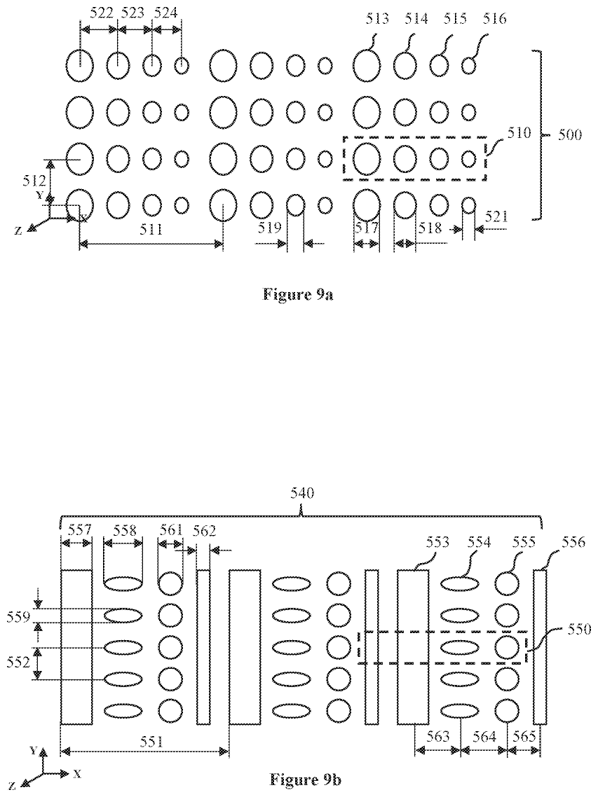

FIG. 9a presents an exemplary design of the polarization-insensitive meta-grating 500 of the first layer facing the incident light. The grating's meta-molecule 510, shown in FIG. 9a by dashed lines, has periodicity in the horizontal 511 and vertical 512 directions. The meta-molecule 510 contains 4 different circular nano-pillars 513, 514, 515, and 516 with respective diameters denoted as 517, 518, 519, and 521. The nano-pillars are spaced at distances 522, 523, and 524. Table 4 contains prescription details of the polarization independent grating 500 of the first layer. The meta-grating structure is fabricated from TiO₂, and is designed to operate at the wavelength of 0.55 microns.

TABLE 4

| | Parameter | | | | |
|---|---|---|---|---|---|
| | TiO₂ | X period | Y period | Diameter | Diameter |
| | layer | 511 | 512 | 517 | 518 |
| | thickness (μ) | (nm) | (nm) | (nm) | (nm) |
| Value | 0.64 | 1130 | 240 | 168 | 147 |

| | Parameter | | | | |
|---|---|---|---|---|---|
| | Diameter | Diameter | X spacing | X spacing | X spacing |
| | 519 | 521 | 522 | 523 | 524 |
| | (nm) | (nm) | (nm) | (nm) | (nm) |
| Value | 129 | 106 | 260 | 240 | 260 |

FIG. 9b presents an exemplary design of the PBS meta-surface 540 of the second layer. The meta-surface is placed onto the PBS substrate surface opposite to the incident light. The PBS meta-molecule 550, shown in FIG. 9b by dashed rectangle, has periodicity in the horizontal 551 and the vertical 552 directions. The meta-molecule 550 contains 4 different sub-wavelength structures: two ridges 553 and 556, an elliptical nano-pillar 554 and a circular nano-pillar 555. The ridges 553 and 556 have respective widths 557 and 562. The elliptical nano-pillar 554 has width 558 and height 559. The circular nano-pillar 555 has diameter 561. The sub-wavelength structures 553, 554, 555 and 556 are spaced at the respective distances 563, 564, and 565. Table 5 provides prescription details of the PBS meta-grating 550 of the second layer. The meta-grating structure is fabricated from Si₃N₄, and is designed to operate at the wavelength of 0.55 microns.

TABLE 5

| | Parameter | | | | |
|---|---|---|---|---|---|
| | Layer | X period | Y period | Ridge X | Ridge X |
| | thickness | 551 | 552 | width 557 | width 562 |
| | (μ) | (nm) | (nm) | (nm) | (nm) |
| Value | 0.645 | 1130 | 160 | 88 | 57 |

| | Parameter | | | | | |
|---|---|---|---|---|---|---|
| | Pillar X | Pillar Y | Pillar | Spacing | Spacing | Spacing |
| | size | size | diameter | 563 | 564 | 565 |
| | 558 (nm) | 559 (nm) | 561 (nm) | (nm) | (nm) | (nm) |
| Value | 105 | 160 | 40 | 240 | 240 | 260 |

When light is incident onto the first meta-surface at normal incidence, both TE-polarized light and TM-polarized light components will be diffracted by the first meta-surface 500 into the substrate at an angle of 19.5 degrees as TE_{0,+1} light and TM_{0,+1} light. Diffraction efficiency of the first meta-surface for both TE_{0,+1} and TM_{0,+1} polarizations is about 92%. When TM-polarized light reaches the second PBS meta-surface at the angle of 19.5 degrees, the TM-polarized light will be transmitted through the meta-surface as TM_{0,+1} light without deflection, and will refract into air at an angle of 29.1 degrees. When TE_{0,+1} light reaches the second PBS meta-surface at an angle of 19.5 degrees, the TE-polarized light will be diffracted by the meta-surface as TE_{0,-1} light, and will exit the meta-surface into air at 0 degrees, collinear to the light incident onto the PBS. Diffraction efficiency of the PBS meta-surface is 94.5% for TM-polarized light and 87% for TE-polarized light.

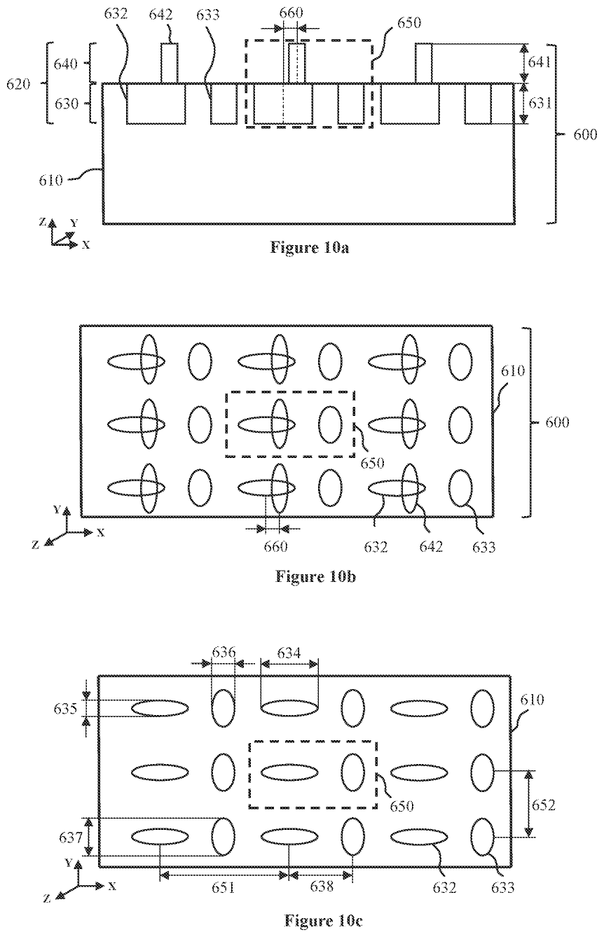

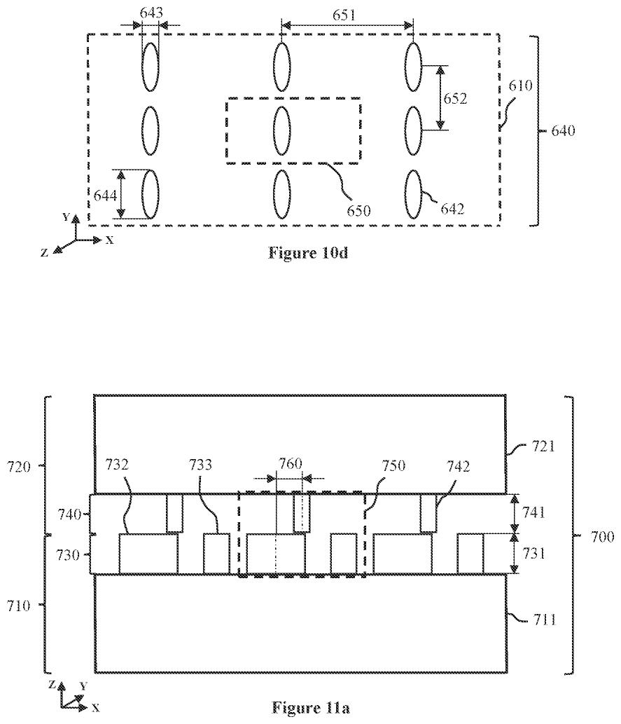

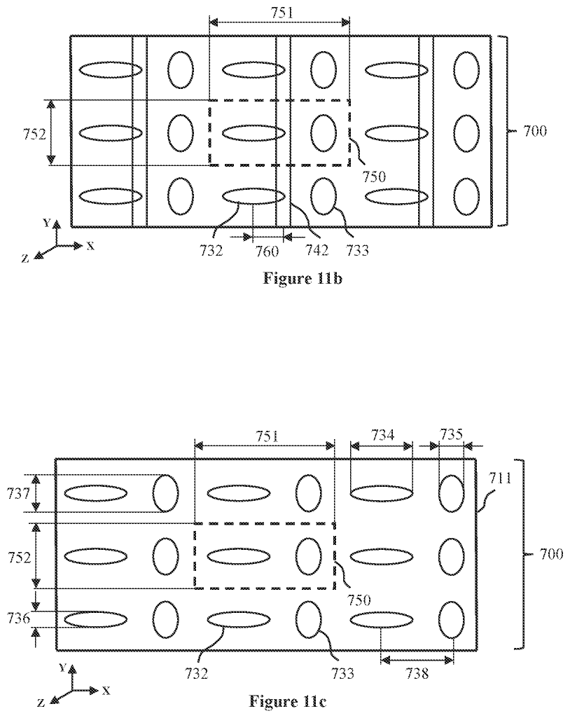

The third meta-surface PBS design example of the first embodiment is based on a two-layer meta-surface approach shown in FIG. 7c. The XZ-plane view of the two-layer meta-surface PBS is shown in FIG. 10a. The two-layer meta-surface PBS 600 consists of a substrate 610 and a two-layer structure 620 fabricated on top of the substrate. The substrate 610 is made of optical material transparent to the PBS operating wavelength. The two meta-surface layers 630 and 640 of the two-layer PBS structure 620 are fabricated sequentially onto the substrate 610, and contain periodically spaced two-layer meta-molecules 650. The layers 630 and 640 have respective thicknesses 631 and 641. Layer 630 is encapsulated with the substrate material, i.e. the high refractive index nano-pillars are surrounded by the lower refractive index material of the substrate 610. The two meta-surface layers are designed to work in combination with each other, jointly producing the desired PBS properties. Meta-molecules of the first layer 630, closest to the substrate, contain two different types of nano-pillars 632 and 633. The second meta-surface layer 640, fabricated on top of the first layer 630, contains single nano-pillar type 642. Nano-pillars 632 and 642 are laterally offset within each meta-molecule 650 in Y-axis direction by distance 660. The value of the lateral offset 660 is 85 nm.

FIG. 10b shows the XY-plane view of the two-layer meta-surface 600. The meta-molecule 650 containing nano-pillars 632, 633 and 642 has periodicity in X-axis and Y-axis directions along the substrate. It also shows the lateral displacement 660 between the nano-pillars 632 and 642 of the meta-surfaces 630 and 640.

FIG. 10c presents details of the meta-surface layer 630 composed of meta-atoms 650. Each meta-atom 650 has horizontal period 651, and vertical period 652. Each meta-atom 650 contains elliptically-shaped nano-pillars 632 and 633. Elliptical nano-pillar 632 has major axis 634 and minor axis 635, with the major axis 634 oriented in horizontal direction along X-axis. Elliptical nano-pillar 633 has major axis 637 and minor axis 636, with the major axis 637 oriented in vertical direction along Y-axis. The horizontal spacing between nano-pillars 632 and 633 is represented by 638.

FIG. 10d presents details of the meta-surface layer 640 where each meta-molecule 650 comprises a single meta-atom 642. Meta-molecules 650 have horizontal X-axis spacing 651 and vertical Y-axis spacing 652. Each meta-molecule 650 is composed of a single elliptically-shaped nano-pillar 642. Elliptical nano-pillars 642 have major axis 644 and minor axis 643, with the major axis 644 oriented in vertical direction along Y-axis.

Table 6 provides construction details of the PBS meta-surface layer 630. The meta-surface structure is fabricated from Si₃N₄, and is designed for operation at the wavelength of 0.55 microns.

TABLE 6

Parameter

| | Layer | X period | Y period | Pillar |
|---|---|---|---|---|
| | thickness | 651 | 652 | spacing |
| | 631 (μ) | (nm) | (nm) | 638 (nm) |
| Value | 0.755 | 710 | 345 | 320 |

Parameter

| | Pillar X | Pillar Y | Pillar X | Pillar Y |
|---|---|---|---|---|
| | size 634 | size 635 | size 636 | size 637 |
| | (nm) | (nm) | (nm) | (nm) |
| Value | 255 | 95 | 125 | 245 |

Table 7 provides construction details of the PBS meta-surface layer 640. The meta-grating structure is fabricated from Si₃N₄, and is designed for operating wavelength of 0.55 microns.

TABLE 7

| | Parameter | | | | |
|---|---|---|---|---|---|
| | Layer | Pillar | Pillar | Pillar X | Pillar Y |
| | thickness | spacing | spacing | size | size |
| | 641 (μ) | 651 (nm) | 652 (nm) | 643 (nm) | 644 (nm) |
| Value | 0.905 | 710 | 345 | 75 | 280 |

When light is incident onto the two-layer PBS meta-structure 600, it will be split into TE and TM polarization states. Nominally, 92% of the TM-polarized light will be transmitted through the PBS without deflection as TM_{0,0} light, and 94.4% of TE-polarized light will be transmitted through the PBS with deflection as TE_{0,+1} light. When the incident light is at normal incidence with respect to the PBS meta-surface, deflection angle of TE_{0,+1} light in air at the output of the PBS meta-structure 600 with respect to the transmitted TM_{0,0} light will be 50.5 deg.

The fourth meta-surface PBS design example of the first embodiment is based on a two-layer meta-surface approach shown in FIG. 7d. The XZ-plane view of the two-layer meta-surface PBS is shown in FIG. 11a. The two-layer meta-surface PBS 700 consists of two meta-surface assemblies 710 and 720. Meta-surface assembly 710 is composed of a substrate 711 and a meta-surface layer 730. Meta-surface assembly 720 is composed of a substrate 721 and a meta-surface layer 740. Meta-surface assemblies 710 and 720 are brought in proximity, with the meta-surface layers 730 and 740 facing each other.

The substrates 711 and 721 are made of optical materials transparent to the PBS operating wavelength. Meta-surface layers 730 and 740 of the two-layer PBS structure 700 contain periodically spaced two-layer meta-molecules 750. The layers 730 and 740 have respective thicknesses 731 and 741. The two meta-surface layers are designed to work in combination with each other, jointly producing the desired PBS properties. Meta-molecules of the first layer 730 contain two different types of nano-pillars 732 and 733. The second meta-surface layer 740 contains single nano-ridge 742. Nano-pillars 732 and 742 are laterally offset in X-axis direction by distance 760. The value of the lateral offset 760 is 120 nm.

FIG. 11b shows the XY-plane view of the two-layer meta-surface 700. The meta-molecule 750 containing nano-pillars 732 and 733, as well as nano-ridge 742, has X-axis dimension 751 and Y-axis dimension 752. It also shows the lateral displacement 760 between the nano-pillar 732 and the nano-ridge 742 within the meta-molecule 750.

FIG. 11c presents the XY-plane view of the meta-surface assembly 710 containing meta-layer 730 fabricated on substrate 711. Meta-layer 730 is composed of elliptically-shaped nano-pillars 732 and 733 fabricated onto the substrate 711. Spacing between the nano-pillars 732 and 733 in X-axis direction is 738. Nano-pillars 732 and 733 are periodically arranged in X-axis and in Y-axis directions. Nano-pillar 732 has major axis 734 oriented in X-axis direction, and minor axis 736 oriented in Y-axis direction. Nano-pillar 733 has major axis 737 oriented in Y-axis direction, and minor axis 735 oriented in X-axis direction.

FIG. 11d presents the XY-plane view of the meta-surface assembly 720 containing meta-layer 740 fabricated on substrate 721. Meta-layer 740 is composed of nano-ridges 742 oriented along the Y-axis direction and periodically spaced by 751 in X-axis direction. Nano-ridges 742 have width 743 in X-axis direction.

Table 8 provides construction details of the PBS meta-surface layer 730 fabricated on the substrate 711. The meta-surface structure is fabricated from Si₃N₄, and is designed for operation at the wavelength of 0.55 microns.

TABLE 8

Parameter

| | Layer | X period | Y period | Pillar |
|---|---|---|---|---|
| | thickness | 751 | 752 | spacing |
| | 731 (μ) | (nm) | (nm) | 738 (nm) |
| Value | 0.815 | 735 | 235 | 340 |

Parameter

| | Pillar X | Pillar Y | Pillar X | Pillar Y |
|---|---|---|---|---|
| | size 734 | size 736 | size 735 | size 737 |
| | (nm) | (nm) | (nm) | (nm) |
| Value | 260 | 65 | 145 | 160 |

Table 9 provides construction details of the PBS meta-surface layer 740 fabricated on the substrate 721. The meta-grating structure is fabricated from Si₃N₄, and is designed for operating wavelength of 0.55 microns.

TABLE 9

Parameter

| | Layer | X period | Y period | Pillar X |
|---|---|---|---|---|
| | thickness | 751 | 752 | width |
| | 741 (μ) | (nm) | (nm) | 743 (nm) |
| Value | 0.875 | 735 | 235 | 45 |

When light is incident onto the two-layer PBS meta-structure 700, it will be split into TE and TM polarization states. Nominally, 98.2% of the TM-polarized light will be transmitted through the PBS without deflection as TM_{0,0} light, and 95.9% of TE-polarized light will be transmitted through the PBS with deflection as TE_{0,+1} light. When the incident light is at normal incidence with respect to the PBS meta-surface, deflection angle of the TE_{0,+1} light at the output of the PBS meta-structure 700 with respect to the transmitted TM_{0,0} light will be 48.4 deg.

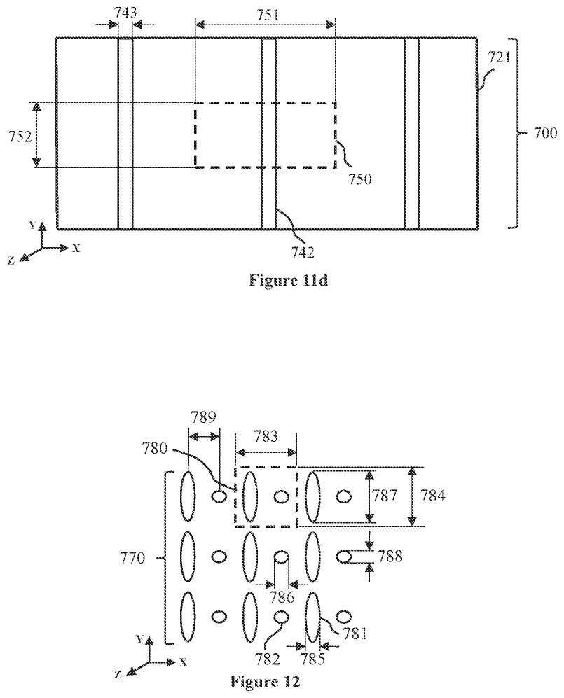

To achieve polarization conversion in accordance with the present invention, PCAs in FIGS. 4, 5 and 6 also contain meta-surface half-wave phase (HWP) retardation structures. FIG. 12 presents the XY-plane view of a HWP meta-surface 770 of the first embodiment, containing a periodic array of meta-molecules 780 tiled in X and Y directions. Each meta-molecule 780 is composed of two elliptically-shaped nano-pillars 781 and 782. Elliptical nano-pillar 781 has major axis size 787 and minor axis size 785, with the major axis oriented in Y-axis direction. Elliptical nano-pillar 782 has major axis size 786 and minor axis size 788, with the major axis oriented in X-axis direction. Metamolecule 780 size in X direction is 783, and in Y direction is 784. Distance between the nano-pillars 781 and 782 is in X direction is 789.

Table 10 provides prescription details of the meta-surface HWP structure 770. The meta-surface HWP structure 770 is fabricated from Si₃N₄, and is designed for operating wavelength of 0.55 microns.

TABLE 10

Parameter

| | Layer | X period | Y period | Pillar |
|---|---|---|---|---|
| | thickness | 783 | 784 | spacing 789 |
| | (μ) | (nm) | (nm) | (nm) |
| Value | 1.04 | 376 | 348 | 188 |

Parameter

| | Pillar X | Pillar Y | Pillar X | Pillar Y |
|---|---|---|---|---|
| | size 785 | size 787 | size 786 | size 788 |
| | (nm) | (nm) | (nm) | (nm) |
| Value | 105 | 280 | 120 | 90 |

The meta-surface HWP structure 770 is highly transmissive to both TE and TM polarizations. Meta-surface HWP 770 with the prescription details defined in Table 10 transmits 98.5% of TE-polarized light and 99.8% of TM-polarized light.

Table 11 provides prescription details of the meta-surface quarter-wave phase (QWP) structure used in FIG. 5c to convert linearly polarized light into circularly polarized light. The nomenclature of the QWP parameters in Table 11 is the same as for the HWP in Table 10. Similar to the HWP meta-surface, the QWP meta-surface is composed of a periodic array of meta-molecules tiled in X and Y directions. Each meta-molecule is also composed of two elliptically shaped nano-pillars. In the case of the QWP, both nano-pillars have their major axes oriented in Y direction. The meta-surface QWP structure is fabricated from Si₃N₄, and is designed for an operating wavelength of 0.55 microns.

TABLE 11

Parameter

| | Layer | X period | Y period | Pillar |
|---|---|---|---|---|
| | thickness | 783 | 784 | spacing 789 |
| | (μ) | (nm) | (nm) | (nm) |
| Value | 1.04 | 376 | 348 | 188 |

Parameter

| | Pillar X | Pillar Y | Pillar X | Pillar Y |
|---|---|---|---|---|
| | size 785 | size 787 | size 786 | size 788 |
| | (nm) | (nm) | (nm) | (nm) |
| Value | 80 | 240 | 90 | 170 |

The meta-surface QWP structure defined in Table 11 is highly transmissive to TE and TM polarizations of light. It transmits 98.1% of TE-polarized light and 99.3% of TM-polarized light.

The light deflector meta-surface of the first embodiment deflects non-zero diffracted orders (0,+1) or (0,−1) to be collinear to the direction of the non-diffracted (0,0) order transformed by the phase retarder meta-surface. The transmissive light deflector meta-surface may have the same structure as one the PBS meta-surfaces defined earlier in FIGS. 8a through 8c, as well as the respective Tables 1 through 3, and is rotated by 180 degrees around the Z axis with respect to the PBS meta-surface. The rotated transmissive meta-surface PBS light deflector diffracts the incident polarized light at an angle equal in magnitude and opposite in direction to the first PBS diffraction angle. The output deflected light from the rotated meta-surface PBS light deflector will be directed along the direction of non-diffracted light, while maintaining the polarization state of the incident light. As a result, the output light from the PCA of the first embodiment will contain a single desired polarization propagating in the direction of the incident light.

### Second Embodiment

The second embodiment of the present invention is based on transmissive meta-surfaces that split incident light into three optical paths with different polarization states. One optical path contains the first polarization state transmitted into (0,0) diffraction order, while the second and third optical paths containing the second polarization state are transmitted into both the (0,+1) and into the (0,−1) diffraction orders. Notation of TE-polarized light in the following associated figures is defines as a solid dot surrounded by a circle. Notation of TM-polarized light in the following associated figures is defines as a double-arrow line drawn perpendicular to the direction of light propagation.

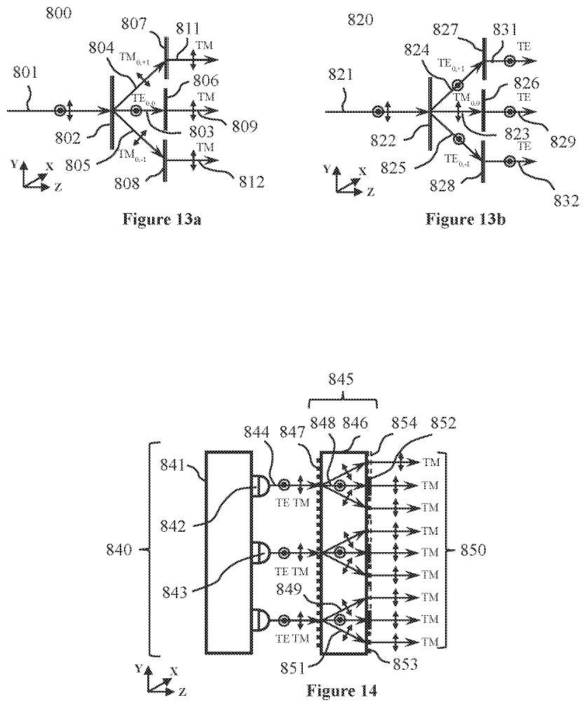

FIGS. 13a and 13b present different variations of the PCAs of the second embodiment. FIG. 13a shows the YZ-plane view of the PCA arrangement 800. PCA arrangement 800 contains transmissive PBS meta-surface 802 that splits the incident light 801 into TE_{0,0} polarization directed into the (0,0) diffraction order 803, into TM_{0,+1} polarization directed into the (0,+1) diffraction order 804, and into TM_{0,-1} polarization directed into the (0,−1) diffraction order 805. Direction of the transmitted TE_{0,0} polarization 803 coincides with the direction of the incident light 801. Direction of the diffracted TM_{0,+1} polarization 804 and TM_{0,-1} polarization 805 are at an angle with respect to the direction of the incident light 801. The PCA 800 also contains the transmissive meta-surface half-wave phase retarder 806 and transmissive meta-surface deflectors 807 and 808. The half-wave retarder 806 transforms incident TE_{0,0} polarization 803 into the output TM-polarized light 809 without changing the propagation direction. Transmissive meta-surface deflector 807 diffracts incident TM_{0,+1} polarization 804 at an angle equal in magnitude and opposite in sign to the diffraction angle TM_{0,+1} polarization 804 by the PBS meta-surface 802. As a result, the output from the transmissive meta-surface deflector 807 will contain TM-polarized light 811 collinear to the TM-polarized light 809 at the output of the phase retarder 806. Transmissive meta-surface deflector 808 diffracts incident TM_{0,-1} polarization 805 at an angle equal in magnitude and opposite in sign to the diffraction angle TM_{0,-1} polarization 805 by the PBS meta-surface 802. As a result, the output from the transmissive meta-surface deflector 808 will contain TM-polarized light 812 collinear to the TM-polarized light 809 at the output of the phase retarder 806. TM-polarized fractions of light 809, 811 and 812 at the output of the PCA 800 are collinear to the incident light 801.

FIG. 13b shows the YZ-plane view of the PCA arrangement 820. PCA arrangement 820 contains a transmissive PBS meta-surface 822 that splits the incident light 821 into TM_{0,0} polarization directed into the (0,0) diffraction order 823, into TE_{0,+1} polarization directed into the (0,+1) diffraction order 824, and into TE_{0,-1} polarization directed into the (0,−1) diffraction order 825. Direction of the transmitted TM_{0,0} polarization 823 coincides with the direction of the incident light 821. Direction of the diffracted TE_{0,+1} polarization 824 and TE_{0,-1} polarization 825 are at an angle with respect to the direction of the incident light 821. The PCA 820 also contains transmissive meta-surface half-wave phase retarder 826 and transmissive meta-surface deflectors 827 and 828. The half-wave retarder 826 transforms incident TM_{0,0} polarization 823 into the output TE-polarized light 829 without changing the propagation direction. Transmissive meta-surface deflector 827 diffracts incident TE_{0,+1} polarization 824 at an angle equal in magnitude and opposite in sign to the diffraction angle TE_{0,+1} polarization 824 by the PBS meta-surface 822. As a result, the output from the transmissive meta-surface deflector 827 will contain TM-polarized light 831 collinear to the TE-polarized light 829 at the output of the phase retarder 826. Transmissive meta-surface deflector 828 diffracts incident TE_{0,-1} polarization 825 at an angle equal in magnitude and opposite in sign to the diffraction angle TE_{0,-1} polarization 825 by the PBS meta-surface 822. As a result, the output from the transmissive meta-surface deflector 828 will contain TM-polarized light 832 collinear to the TM-polarized light 829 at the output of the phase retarder 826. TM-polarized fractions of light 829, 831 and 832 at the output of the PCA 820 are collinear to the incident light 821.

FIG. 14 presents the YZ-plane view of a PCA assembly 840 in accordance with the second embodiment of the invention that converts collimated incident light from an array of light sources, such as LEDs, OLEDs, or VCSELs, into TM-polarized output light that is collinear with the direction of the incident light. The array of light sources is comprised of a number of individual emitters 842 assembled onto the substrate 841. Emitters 842 may contain micro-lenses 843 for reducing divergence of light from the emitters 842. While refractive micro-lenses are shown in FIG. 14, diffractive micro-lenses or meta-optics micro-lenses can be also integrated with the light sources 842. A micro-lens array with the lens spacings matching the spacing between emitters 842 can be also placed in proximity to the emitter array to perform light collimation. Input light 844 emitted by an array of emitters 842 is directed onto a monolithic meta-surface assembly 845. The meta-surface assembly 845 includes a substrate 846 containing two meta-surface layers fabricated on both sides of the substrate. Collimated light 844 is incident onto the first meta-surface layer 847 that functions as a PBS that transmits TE-polarized light 848 with no deviation from its original direction, and deflects TM-polarized light components 849 and 851. TE and TM polarizations are spatially separated from each other as they reach the opposite surface of the substrate 846. Individual fractions of TE-polarized light 848 are incident onto sub-regions 852 of the second meta-surface layer that work as half-wave phase structures. The half-wave phase structures 852 transform incident TE-polarized light 848 into TM-polarized light 850 that travels collinear with the direction of incident light 844. Individual fractions 849 and 851 of TM-polarized light deflected by the meta-surface layer 847 are incident onto the respective sub-regions 853 and 854 of the second meta-surface layer. Sub-regions 853 and 854 function as transmissive light deflectors by diffracting the incident light. Deflector sub-regions 853 and 854 diffract TM-polarized light at angles equal in magnitude and opposite in sign to the diffraction angles of the first meta-surface layer 847. TM-polarized fractions of light at the output of the meta-surface sub-regions 853 and 854 are collinear with the direction of the incident light 844 and with the TM-polarized light transformed by half-wave phase meta-surface structures 852.

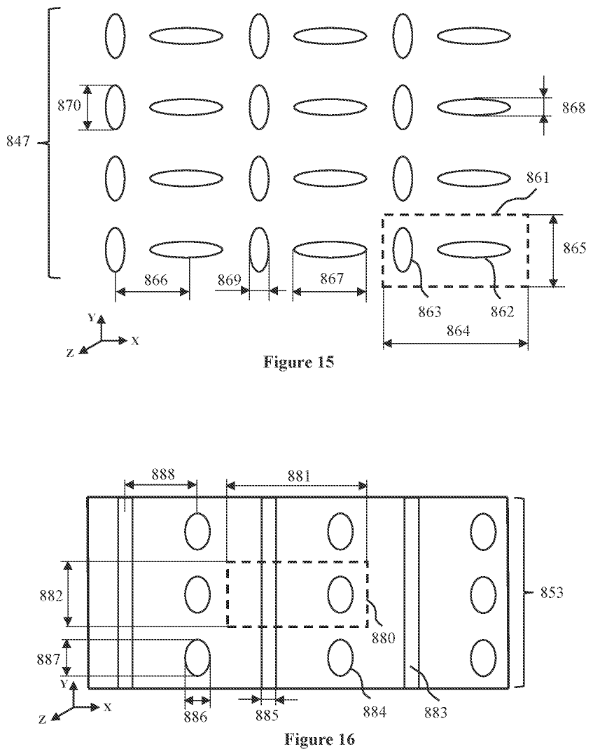

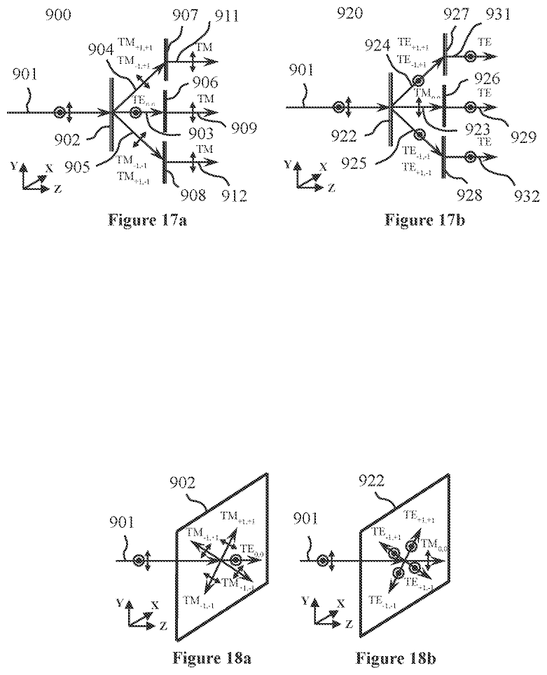

FIG. 15 presents an exemplary design of a single layer transmissive meta-surface PBS 847 of the second embodiment. The meta-surface PBS structure is fabricated from Si₃N₄ layer, and is designed to operate at the wavelength of 0.55 microns. Meta-surface PBS is composed of meta-molecules 861, shown in FIG. 15 by dashed lines, that are periodically tiled in the X and Y directions. Meta-molecules 861 have X-axis period 864 and Y-axis period 865, and are composed of 2 different elliptically-shaped nano-pillars 862 and 863. The distance between the nano-pillars in the X-axis is 866. The meta-surface is placed onto the PBS substrate from the side facing the incident light. Nanopillars 862 have major axis size 867 and minor axis size 868. The major axis of nano-pillars 862 is oriented in the X-direction. Nanopillars 863 have major axis size 870 and minor axis size 869. The major axis of nano-pillars 863 is oriented in the Y-direction. Table 12 contains prescription details of the PBS meta-surface 847 of the second embodiment shown in FIG. 15.

TABLE 12

Parameter

| | X period | Y period | Pillar | Layer |
|---|---|---|---|---|
| | 864 | 865 | spacing | thickness |
| | (nm) | (nm) | 866 (nm) | (μ) |
| Value | 754 | 340 | 377 | 0.58 |

Parameter

| | Pillar X | Pillar Y | Pillar X | Pillar Y |
|---|---|---|---|---|
| | size | size | size 869 | size 870 |
| | 867 (nm) | 868 (nm) | (nm) | (nm) |
| Value | 370 | 145 | 85 | 275 |

When the light is incident onto the transmissive meta-surface PBS layer 847, it will be split into TE and TM polarization states. Nominally, 97.4% of the TE-polarized light will be transmitted through the PBS without deflection as TE_{0,0} light, and 47.5% of TM-polarized light will be deflected by the PBS into each of the diffraction orders TM_{0,+1} and TM_{0,-1}. When the incident light is at normal incidence with respect to the PBS meta-surface, deflection angle of TM_{0,+1} and TM_{0,-1} light into the PBS substrate with respect to the transmitted TE_{0,0} light will be +29.9 degrees and −29.9 degrees, respectively.

Half-wave meta-surface phase sub-regions 852 in FIG. 14 have the same prescription as the half-wave meta-surface phase structures of the first embodiment defined earlier in FIG. 12 and in Table 10.

Transmissive meta-surface deflection gratings of the second embodiment are used to fabricate meta-surface deflector sub-regions 853 and 854 shown in FIG. 15. The meta-gratings are designed to diffract the incident light at angles equal in magnitude and opposite in sign to the diffraction angles of the first meta-surface layer 847. The meta-surface deflector sub-regions 853 and 854 shown in FIG. 15 have the same optical prescription, and are oriented at 180 degrees in XY-plane with respect to each other, where deflection angles are produced in YZ-plane.

The light deflector meta-surface of the second embodiment deflects non-zero diffracted orders (0,+1) and (0,−1) to be collinear to the direction of the non-diffracted (0,0) order transformed by the phase retarder meta-surface. The transmissive light deflector meta-surface is made as one a meta-surface grating that diffracts the incident polarized light at an angle equal in magnitude and opposite in direction to the diffraction angle of the incident light from the transmissive PBS meta-surface. The output deflected light from the meta-surface grating light deflector will be directed along the direction of non-diffracted light, while maintaining the polarization state of the incident light. As a result, the output light from the PCA of the second embodiment will contain a single desired polarization propagating in the direction of the incident light.

FIG. 16 presents an exemplary design of a transmissive meta-surface deflection gratings 853 and 854 of the second embodiment. The meta-surface gratings are fabricated from Si₃N₄, and are designed to operate at the wavelength of 0.55 microns. The meta-surface deflector is composed of meta-molecules 880, shown in FIG. 16 by dashed lines. The meta-molecules are periodically tiled in the X and Y directions. Meta-molecules 880 have X-axis period 881 and Y-axis period 882, and are composed of an elliptically-shaped nano-pillar 884 and a nano-ridge 883. The distance between the nano-pillar and ridge in the X-axis is 888. Nanopillars 884 have major axis size 887 and minor axis size 886. The major axis of nano-pillars 884 is oriented in the Y-direction. Nano-ridges 883 are oriented along the Y axis direction.

Table 13 contains prescription details of an exemplary transmissive light deflector meta-surface of the second embodiment shown in FIG. 16.

TABLE 13

Parameter

| | Ridge X | Pillar X | Pillar Y | Si₃N₄ |
|---|---|---|---|---|
| | width | size | size | layer |
| | 885 (nm) | 886 (nm) | 887 (nm) | thickness (μ) |
| Value | 225 | 160 | 300 | 0.480 |

| | Parameter | | |
|---|---|---|---|
| | X period | Y period | X spacing |
| | 881 (nm) | 882 (nm) | 888 (nm) |
| Value | 755 | 335 | 505 |

Nominally, 86.2% of the TM-polarized light will be deflected by the gratings 853 and 854, and directed collinear to the incident light.

### Third Embodiment

The third embodiment of the present invention is based on transmissive meta-surfaces that split the incident light into more than three optical paths with different polarization states. While the teachings of the present invention can be applied to split the incident light into different number of optical paths larger than three, the specific design example of the third embodiment demonstrates polarization beam splitting of incident light into 5 different optical paths with different polarization states. One optical path contains first polarization state transmitted into (0,0) diffraction order, while the rest of the optical paths contain second polarization state, diffracted into (−1,−1), (−1,+1), (+1,−1), and into (+1,+1) diffraction orders. Notation of TE-polarized light in the following associated figures is defines as a solid dot surrounded by a circle. Notation of TM-polarized light in the following associated figures is defines as a double-arrow line drawn perpendicular to the direction of light propagation.

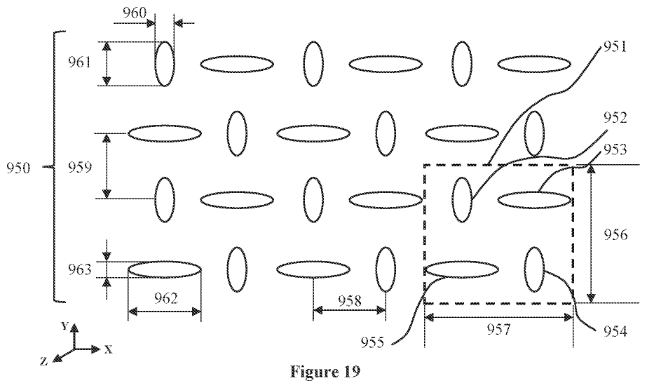

FIGS. 17a and 17b present two variations of transmissive meta-surface PBSs of the third embodiment. FIG. 17a shows a schematic layout of the transmissive PBS meta-surface 902 that splits the incident light 901 into TE_{0,0} polarization directed into the (0,0) diffraction order 903, into TM_{+1,+1} polarization directed into the (+1,+1) diffraction order 904, into TM_{-1,+1} polarization directed into the (−1,+1) diffraction order 905, into TM_{+1,-1} polarization directed into the (+1,−1) diffraction order 906, and into TM_{-1,-1} polarization directed into the (−1,−1) diffraction order 907. Direction of the transmitted TE_{0,0} polarization 903 coincides with the direction of the incident light 901. Diffracted orders containing TM polarization are directed at an angle with respect to the direction of the incident light 901. FIG. 17b shows a schematic layout of the transmissive PBS meta-surface 922 that splits the incident light 901 into TM_{0,0} polarization directed into the (0,0) diffraction order 923, into TE_{+1,+1} polarization directed into the (+1,+1) diffraction order 924, into TE_{-1,+1} polarization directed into the (−1,+1) diffraction order 925, into TE_{+1,-1} polarization directed into the (+1,−1) diffraction order 926, and into TE_{-1,-1} polarization directed into the (−1,−1) diffraction order 927. Direction of the transmitted TM_{0,0} polarization 923 coincides with the direction of the incident light 901. Diffracted orders containing TE polarization are directed at an angle with respect to the direction of the incident light 901.

FIGS. 18a and 18b present two variations of the PCAs of the third embodiment containing PBSs shown in FIGS. 17a and 17b, respectively. FIG. 18a shows a schematic layout of the PCA arrangement 900 containing transmissive PBS meta-surface 902 that splits the incident light 901 into TE_{0,0} polarization directed into the (0,0) diffraction order 903, into TM_{+1,+1} polarization directed into the (+1,+1) diffraction order 904, into TM_{-1,+1} polarization directed into the (−1,+1) diffraction order 905, into TM_{+1,-1} polarization directed into the (+1,−1) diffraction order 906, and into TM_{-1,-1} polarization directed into the (−1,−1) diffraction order 907. Direction of the transmitted TE_{0,0} polarization 903 coincides with the direction of the incident light 901. Diffracted orders containing TM polarization are directed at an angle with respect to the direction of the incident light 901.

FIG. 18b shows a schematic layout of the PCA arrangement 920 containing transmissive PBS meta-surface 922 that splits the incident light 901 into TM_{0,0} polarization directed into the (0,0) diffraction order 923, into TE_{+1,+1} polarization directed into the (+1,+1) diffraction order 924, into TE_{-1,+1} polarization directed into the (−1,+1) diffraction order 925, into TE_{+1,-1} polarization directed into the (+1,−1) diffraction order 926, and into TE_{-1,-1} polarization directed into the (−1,−1) diffraction order 927. Direction of the transmitted TM_{0,0} polarization 923 coincides with the direction of the incident light 901. Diffracted orders containing TE polarization are directed at an angle with respect to the direction of the incident light 901.

FIG. 19 presents an exemplary design of a single layer transmissive meta-surface PBS 950 of the second embodiment. The meta-surface PBS structure is fabricated from Si₃N₄ layer, and is designed to operate at the wavelength of 0.55 microns. The meta-surface PBS is composed of meta-molecules 951, shown in FIG. 18 by dashed lines, that are periodically tiled in the X and Y axes. Meta-molecules 951 have X-axis period 957 and Y-axis period 956, and are composed of 4 different elliptically-shaped nano-pillars 952, 953, 954, and 955. Pillar 952 is identical in size and shape to pillar 954. Similarly, pillar 953 is identical in size and shape to pillar 955. The distance between the nano-pillars in the X direction is 958 and in the Y-direction is 959. The meta-surface is placed on the PBS substrate from the side illuminated by the incident light. Nanopillars 952 and 954 have major axis size 961 and minor axis size 960. The major axes of nano-pillars 952 and 954 are oriented in the Y-axis. Nanopillars 953 and 955 have major axis size 962 and minor axis size 963. The major axis of nano-pillars 953 and 955 is oriented in the X-axis. Table 14 contains prescription details of the PBS meta-surface 950 of the third embodiment shown in FIG. 19.

TABLE 14

Parameter

| | X period | Y period | Pillar | Layer |
|---|---|---|---|---|
| | 957 | 956 | spacings 958 | thickness |
| | (nm) | (nm) | and 959 (nm) | (μ) |
| Value | 736 | 736 | 368 | 0.547 |

| | Parameter | | | |
|---|---|---|---|---|
| | Pillar 952, 954 | Pillar 952, 954 | Pillar 953, 955 | Pillar 953, 955 |
| | X size 960 | Y size 961 | X size 962 | Y size 963 |
| | (nm) | (nm) | (nm) | (nm) |
| Value | 300 | 145 | 75 | 315 |

When the light is incident onto the transmissive meta-surface PBS layer 950, it will be split into TE and TM polarization states. Nominally, 99.7% of the TE-polarized light will be transmitted through the PBS without deflection as TE_{0,0} light, and 24.7% of TM-polarized light will be deflected by the PBS into each of the four diffraction orders TM_{+1,+1}, TM_{-1,+1}, TM_{+1,-1} and TM_{-1,-1}.

The phase delay meta-surfaces 906 in FIGS. 17a and 926 in FIG. 17b can be made with the same prescriptions as the half-wave meta-surface phase structures of the first embodiment defined earlier in FIG. 12 and in Table 10. Deflection gratings of the third embodiment can be also made in a similar manner to the deflection gratings of the second embodiment defined earlier in FIG. 16 and in Table 13.

What is claimed is:

1. A polarization-separating device, comprising:
an optically transmitting substrate;
a transmissive meta-surface structure disposed on the substrate, the transmissive meta-surface structure being configured to:
(i) receive incident light;
(ii) angularly separate the incident light into orthogonal polarization components;
(iii) wherein a first polarization component is transmitted by said meta-surface structure without altering a propagation direction of the first polarization component;
(iv) and wherein a second polarization component is directed by said meta-surface structure at a non-zero angle with respect to a propagation direction of the incident light.

2. The device of claim 1, whereas the second polarization component is directed in multiple angular directions.

3. The device of claim 1, whereas the first polarization component is TE-polarized and the second polarization component is TM-polarized.

4. The device of claim 1, whereas the first polarization component is TM-polarized and the second polarization component is TE-polarized.

5. The device of claim 1, wherein the polarization-separating device includes a single meta-surface layer.

6. The device of claim 1, wherein the polarization-separating device includes at least two meta-surface layers.

7. The device of claim 1, wherein the incident light is received from a collimated source.

8. A device for introducing controlled phase delays to polarized light components, comprising:
an optically transmitting substrate;
a transmissive meta-surface structure disposed on the substrate, the transmissive meta-surface structure including periodic arrays of two alternating nano-pillars;
and the transmissive meta-surface structure being configured to:
(i) receive incident light;
(ii) introduce a controlled phase delay within at least one of the polarized light components;
(iii) wherein said controlled phase delay introduced by the meta-surface structure is produced without altering a propagation direction of the incident light;
(iv) and wherein the two alternating nano-pillars have differing sizes.

9. The device of claim 8, whereas the two alternating nano-pillars have elliptical cross-sections.

10. The device of claim 8, whereas the introduced controlled phase delay is 180 degrees.

11. The device of claim 8, whereas the introduced controlled phase delay is 90 degrees.

12. A device, comprising:
a first optical element including a meta-surface structure of a first type configured to:
(i) receive incident light;
(ii) angularly separate the incident light into two polarization components;
(iii) transmit a first polarization component in a direction of the incident light;
(iv) direct a second polarization component at a non-zero angle with respect to the incident light;
a second optical element including a meta-surface structure of a second type optically coupled to the meta-surface polarization separating structure of the first type, the meta-surface structure of the second type being configured to:
(i) receive the first polarization component from the first optical element;
(ii) transform the first polarization component into a second polarization component;
(iii) transmit the second polarization component in a direction of the incident light received by the first optical element;
a third optical element including a meta-surface structure of the third type optically coupled to the meta-surface polarization separating structure of the first type, the meta-surface structure of the third type being configured to
(i) receive the second polarization component from the first optical element;
(ii) modify the direction of the received second polarization component by deflecting the received second polarization component at non-zero angle with respect to an incident angle onto the third optical element;

13. The device of claim 12, wherein output light transmitted by the device is TE-polarized.

14. The device of claim 12, wherein output light transmitted by the device is TM-polarized.

15. The device of claim 12, wherein the second polarization component from the meta-surface polarization separating structure of the first type is directed in multiple angular directions.

16. The device of claim 15, wherein multiple second polarization components directed in multiple angular directions by the meta-surface polarization separating structure of the first type are deflected by multiple optically coupled meta-surface structures of the third type.

17. The device of claim 16, wherein the meta-surface structures of the third type are configured to deflect the received second polarization components in a direction of the incident light received by the meta-surface polarization separating structures of the first type.

18. The device of claim 16, wherein the meta-surface structures of the third type are configured to deflect the received second polarization components at an angle that is equal in magnitude and opposite in direction to the angle deflected by the meta-surface polarization separating structures of the first type.

19. A device, comprising:
a first optical element including multiple meta-surface polarization beam-splitting sub-regions of a first type configured to:
(i) receive incident light by the meta-surface sub-regions;
(ii) transmit a first polarization component by the meta-surface sub-regions in a direction of the incident light;
(iii) direct a second polarization component by the meta-surface sub-regions at a non-zero angle with respect to the incident light;
a second optical element including multiple meta-surface sub-regions of a second type and a third type, coupled to the meta-surface sub-regions of the first type, wherein
the meta-surface sub-regions of the second type are configured to:
(i) receive the first polarization component from the meta-surface sub-regions of the first type;
(ii) transform the first polarization component into a second polarization component;
(iii) transmit the second orthogonal polarization component in the direction of the incident light;
the meta-surface sub-regions of the third type are configured to:
(i) receive the second polarization component from the meta-surface sub-regions of the first type;
(ii) modify the direction of the received second polarization component by deflecting the received second polarization component at a non-zero angle with respect to the incident angle onto the third optical element.

20. The device of claim 19, wherein output light transmitted by the device is TE-polarized.

21. The device of claim 19, wherein output light transmitted by the device is TM-polarized.

22. The device of claim 19, wherein the second polarization component from the meta-surface sub-regions of the first type is directed in multiple angular directions.

23. The device of claim 22, wherein light from multiple beams of the second polarization component angularly directed by the meta-surface polarization separating structure of the first type are deflected by multiple meta-surface sub-regions of the third type at multiple angles with respect to the incident angle.

24. The device of claim 19, wherein meta-surface sub-regions of the third type are configured to deflect the received second polarization component in the direction of the incident light received by the meta-surface polarization separating sub-regions of the first type.

25. The device of claim 19, wherein the meta-surface sub-regions of the third type are configured to deflect the received second polarization component at an angle that is equal in magnitude and opposite in direction to an angle directed by the meta-surface polarization separating sub-regions of the first type.

26. The device of claim 19, wherein the incident light originates from an array of sources optically coupled to the meta-surface polarization separating sub-regions of the first type.

27. The device of claim 26, wherein individual ones of the sources in the array include micro-lenses to reduce divergence of emitted light.
